(19) United States
(12) Patent Application Publication
(10) Pub. No.: US 2018/0114083 A1
(43) Pub. Date: Apr. 26, 2018

(54) SYSTEM AND METHOD FOR LABELLING A PRODUCT

(71) Applicant: CREWPHARM GMBH, Helle/Saale (DE)

(72) Inventors: Klaus RICHTER, Magdeburg (DE); Frank CSEHAN, Hohen Neuendorf (DE); Harald CSEHAN, Halle / Saale (DE); Carsten HOPPE, Halle / Saale (DE)

(73) Assignee: Crewpharm GmbH, Kabelsketal / Dölbau (DE)

(21) Appl. No.: 15/567,196

(22) PCT Filed: Apr. 18, 2016
(86) PCT No.: PCT/EP2016/058586

§ 371 Date: Oct. 17, 2017

(30) Foreign Application Priority Data
Apr. 17, 2015 (DE) 10 2015 207 032.8

(51) Int. Cl. G06K 9/18; G06K 19/06; G06K 7/14; G09F 3/00

(52) U.S. Cl. CPC G06K 9/18; G06K 19/06037; G06Q 50/04; G09F 3/0297; G06K 7/1417

(57) ABSTRACT

A system and a method for applying and/or reading a labelling of a product. Here, the system for applying a labelling of the product includes a picture generator, configured for producing a picture pattern and for the pictorial fragmentation of the produced picture pattern into at least two picture parts, an application device configured for applying at least one of the picture parts onto at least one part of the product, as well as a first computation unit, including a first data bank, configured for storing a representation of the produced picture pattern. The system for reading the labelling of the product includes a second computation unit, including a second data bank, configured for storing a representation of a picture pattern, as well as a verification device, configured for reading at least two picture parts, for putting together the picture parts into a composite picture pattern and for verifying the composite picture pattern.

The invention relates to a system as well as to a method for labelling products, wherein the counterfeit protection is increased by the labelling.

There are still insufficient possibilities for producing and using inexpensive, counterfeit-proof labellings of products. In particular, the authenticity is particularly important with regard to medicine, since there is a great risk to the patient in the case of counterfeit medicine.

A system and a method for labelling products are known from US 2006/0255132 A1. Here, a code is applied onto a packaging and a part-code of the code on the packaging is likewise applied inside the packaging, so that the user can compare both codes. Here, the comparison is effected visually by the final customer by way of laying the different code parts next to one another.

The SecurPharm initiative (www.securpharm.de) serves for implementing EU guidelines for the counterfeit protection of medicines. Here, the currently tested method envisages each medicine packaging being provided with a serialised data matrix code which for verification is scanned when being dispensed at the chemists. The feedback provides information as to whether this code actually exists and if so, as to the status of the packaging which is noted there. If the package is dispensed, then this changes the status to “dispensed”. If a second package with an identical serial number and product number is now to be verified, it is evident that these have already been used.

The object of the present protective right application is to increase the counterfeit protection of medicines and in particular to provide the end user with a possibility of examining the authenticity of the medicine.

This is achieved by a system and a method according to the independent claims. Advantageous further developments are moreover specified in the dependent claims.

The system for applying (attaching, depositing, incorporating) and/or reading a labelling of the product comprises a system for applying the labelling of the product and/or a system for reading the labelling of a product.

Here, the system for applying the labelling of the product comprises a picture generator which is configured for the production of a picture pattern, such as for example a two-dimensional bar code, and for the pictorial fragmentation of the produced picture pattern into at least two picture parts. The system for applying the labelling of the product moreover comprises an application device which is configured for applying at least one of the picture parts onto at least one part of the product. The application of the picture parts can be effected for example by way of printing, embossing, removing parts of the surface, bonding on a labelling, perforating the product or its packaging or by way of a combination of the aforesaid application methods. The system for the application further comprises first computation unit comprising a first data bank, configured for storing a representation of the produced picture pattern. The first computation unit and/or the first data bank can hereby be arranged centrally, for example on a server of the manufacturer or decentrally on different servers, computers or other data memories.

The system for reading the labelling of the product comprises a second computation unit comprising a data bank, configured for storing a representation of a picture pattern. The system for reading the labelling of a product moreover comprises a verification device which is configured for detecting and/or reading at least two picture parts, for putting together the picture parts into a composite picture pattern and for verifying the composite picture pattern on the basis of the representation of the picture pattern which is stored in the second data bank.

Here, the detection and/or reading can be effected for example by a scanner, a camera, which can be arranged in a smartphone, tablet or the like, or by way of a scanning device. For example a mechanical, optical, digital or analog reading of the labelling is therefore possible.

The second computation unit and/or the second data bank can be arranged centrally or decentrally, just as the first computation unit and the first data bank. It is possible for the first data bank to be identical to the second data bank, or for the first and the second data bank to be kept separately for the data protection of the end customer vis-a-vis the manufacturer.

The method for applying and/or reading a labelling of a product comprises the following steps for applying the labelling onto the product and/or for reading the labelling of the product.

The method for applying the labelling onto the product is effected by producing a picture pattern, fragmenting the picture pattern into at least two parts, storing the picture pattern in a first data bank of a first computation unit, as well as by applying at least one of the picture parts onto the product. Information on the type of coding as well as on the correct putting-together of the picture parts can possibly be contained in the picture parts. Here too, it is possible for information on the position of the further picture parts to be contained in at least one of the picture parts. Here, the first computation unit as well as the first data bank can be arranged centrally or decentrally, just as with the aforementioned system for applying a labelling.

Here, the creation as well as fragmentation of the picture pattern can be effected by way of a computer-implemented algorithm which can be parameterised, so that it can be possible to vary parts of the picture pattern from product to product or from series to series, whist all other parts of the picture pattern remain the same.

The method for reading the labelling of the product is effected by way of detecting at least one picture part which is applied to the product, by way of putting together the picture parts into a composite picture pattern, as well as by way of comparing the composite picture pattern with a picture pattern which is stored in a second data bank of a second computation unit. Here, just as with the aforementioned system for reading a labelling, the second computation unit as well as the second data bank can be arranged centrally or decentrally.

The putting-together of the picture parts into a composite picture pattern can be effected for example by way of a further computer-implemented algorithm, wherein it is possible for the picture parts to contain information which is necessary or at least helpful for the correct putting-together. For example, at least one of the picture parts, preferably the picture part which is probably seen and detected first of all by the user can also contain information on the position of the further picture parts. This information can be decoded for example immediately after detecting the picture part and be displayed for the user, for example on a smartphone or in the display of a special read device. By way of this, it can also be possible to integrate picture parts into the product or its packaging such that they cannot be perceived at all by the user as being parts of a coding. For example, after the detecting of the first picture part, the user can receive the instruction to likewise detect the rear side of the product by way of the read device.

It is also possible by way of the disclosed system or method for example to convert picture pattern into picture patter with the same information content in a different form. For example, a square picture pattern can be fragmented into two equally large rectangles which are then printed one after the other, by which a means rectangular picture pattern arises. More complicated shapes such as circles, hexagons or arbitrary polygons are also possible. The reconstruction of the original picture pattern can then be effected by way of an algorithm which is implemented by computer. The picture pattern could possibly also be selected such that only one arrangement of the picture parts results in a picture pattern which can be interpreted by the algorithm.

Concerning the disclosed system or method, the picture parts can be deposited and read more rapidly than the complete picture pattern on account of their smaller size. Moreover, it is possible to apply the picture parts at different locations of the product, which further renders the counterfeiting of the labelling more difficult.

Here, it can be possible for the picture generator to moreover be configured for producing and fragmenting the picture pattern in a manner such that each of the picture parts comprises individual information which cannot be reconstructed from the other picture parts. The counterfeiting of the labelling is further rendered more difficult on account of this, since a counterfeiting is only possible with the knowledge of all picture parts.

It can be advantageous for the produced picture pattern to comprise redundancies, in order to permit the reading and verification of the picture parts even when one or several picture parts are damaged, for example due to contamination, scratches or tears. The degree and type of the redundancies here can be directed to the type of expected damage as well as to the number and arrangement of the picture parts.

It is further possible for the produced picture pattern to be a plane, two dimensional picture pattern, for example a data matrix code or a QR code. This type of labelling is simple and inexpensive to create and to read due to the already existing software and hardware, such as, for example, read devices.

As an alternative to a plane picture pattern, it is also further possible for the produced picture pattern to comprise prominences, for example three-dimensional prominences, for example by way of a multi-layered construction. A labelling with prominences is more complicated in manufacture, but provides an improved protection from counterfeits.

The produced picture pattern can be fragmented for example into 2 to 6, preferably into 3 or 4 picture parts depending on the type of the product. It is therefore possible to place the different picture parts onto different product parts and therefore to ensure a correct composition of the product.

The produced picture pattern can possibly be serialised and be provided for application onto precisely one product, for the improved protection from counterfeits. In this case, the second construction unit can moreover be configured for marking the representation of the stored picture pattern in the second data bank after the verification of the compiled picture pattern on the basis of the representation of the picture pattern which is stored in the second data bank.

With the repeated attempt at reading and verifying a composite picture pattern, an error notice can be generated due to the marking of the representation of the picture pattern in the second data bank, said error notice warning the user for example of using the product since its authenticity cannot be guaranteed.

It is moreover possible for the picture pattern to be a multi-coloured picture pattern, so that the colours can provide a further feature for verifying the authenticity of the labelling. Picture patterns which comprise perforations can also be used for the labelling, possibly also in combination with coloured and/or raised picture patterns.

The application device can advantageously comprise an ablative or abrasive laser which applies at least one picture part onto at least a part of the product. Further possibilities for applying the picture parts are given by way of printers, laser printers, embossing devices, bonding on a picture pattern, detaching-away, etching-away or perforating the surface and combinations of the aforesaid devices and methods for applying a labelling.

Lasers operating ablatively can produce a labelling by way of removing material of a surface by way of shooting with a pulsed laser radiation. This procedure is also called laser evaporation and in particular can also be used for the production of picture patterns with prominences. The construction of an ablative layer in the standard manner includes for example two mirrors and a lens, wherein the mirrors are movable via a laser control and hence span a so-called marking field of the laser, wherein a marking is possible within the marking field only by way of rotations of the mirrors (of which for example one defines the x-position and the other the y-position within the marking field) and without movement of the complete laser. The marking field for example can be between 50 mm and 250 mm wide and between 50 mm and 250 mm long. Preferably, the marking field can be 120 mm×120 mm large. In contrast to this, the labelling can be produced by way of partial scraping away of the surface in the case of abrasion. Here, it is also possible to produce picture patterns with prominences.

Moreover, a coloured picture pattern can be produced with ablative or abrasive layer methods in combination with a multi-layered, multi-coloured surface.

Ablative or abrasive lasers operate more slowly compared to common laser printing methods, so that the speed of the labelling and hence the speed of product manufacture depends on the size, in particular on the width of the applied labelling. Here for example, it is possible to deposit several smaller picture parts in parallel or in series by way of several different lasers instead of a depositing a continuous, larger labelling by way of a single laser. A continuous labelling can hence be deposited in small strips by several serially operating lasers, in order to increase the speed of the conveyor belt and thus the manufacturing speed. The exact alignment of the product is of great importance on serially depositing a continuous labelling in strips, in order to permit a later reading of the continuous labelling.

The width of individual picture strips can depend on a predefined operating width and/or one which is inherent of the design, of the application device, for example of the laser. Here, the operating width is defined as the maximal width of a labelling which can be applied onto a plane surface by the application device without moving the application device. The operating width of the application device can be known beforehand, so that the picture generator can be configured to take into account the operating width on creating and/or fragmenting the picture pattern. Here, the picture strips for example can be straight strips or arcuate, bent elliptical and/or irregular strips. For depositing arcuate steps, a laser can be moved along a guide whilst the products are stationary, and/or the products can be moved, for example on a conveyor belt. A strip which maximally has a predefined width, in the context of the present invention can therefore have different widths along the strip, said widths however always lying below the predefined maximal width. Zigzag or wave-like strips are also possible, just as closed circles, ellipses or polygons.

The operating width of an ablative laser can be fixed for example by way of a width of the marking field of the laser. It is also possible via the laser control to set an operating width which is smaller than the width of the marking field, since narrower labellings can often be produced more quickly. The operating widths, in the interest of a labelling which is created as rapidly as possible, can then for example be between 1 cm and 10 cm, preferably between 3 cm and 6 cm.

Moreover, it can be advantageous if the system for the labelling the product comprises a movable unit which is suitable for moving the application device and the product relative to one another.

Here, the product can be moved for example on a conveyor belt past the application device, for example an ablative or abrasive laser. It is possible to stop or slow down the conveying belt during the depositing of the labelling onto the product or, given a suitable speed of the conveying belt and of the application device, it can also be possible to continuously manufacture the labellings in the case of an unchanged transport speed.

This can be possible for example if, due to the fragmentation of the picture pattern, the picture parts are narrow enough, in order to be applied by an ablative or abrasive laser given the transport speed of the conveying belt.

Conversely, in another embodiment it can also be possible for the application device to move, for example by way of the laser being temporarily continuously moved, whilst the products at least temporarily remain stationary.

It is therefore possible for the application of the picture parts onto the product to be effected on a movable unit and/or with a movable or stationary ablative or abrasive laser. A movable laser can be moved dynamically along a predefined guide or be freely movable within a predefined region. Concerning freely movable lasers, the position of the laser can be freely selected manually or automatically by way of inputting coordinates within the region defined by the laser. The laser can then for example deposit a labelling in the width of its operating width at every position.

On using a stationary or statically assembled laser, the material feed can be effected simultaneously with the marking, for example by a conveying belt or by a magazine system. A deposition of arcuate, bent and/or irregular picture parts or picture strips is also possible given the use of a stationary laser, since the stationary laser permits a flexible labelling within its marking field.

A flexible guidance of the laser beam for the efficient production of segmented picture patterns or codings is possible with a movable as well as with a stationary laser due to the flexible alignment of the mirrors of the laser in the x- and y-position.

With regard to the system and/or to the method for labelling the product, it can further be advantageous if the first computation unit is identical to the second computation unit. It is also possible for only the first and the second data bank to be identical and/or for the picture pattern which is stored in the first data bank or its representation, and the picture pattern which is stored in the second data bank or its representation, to be identical. Here, what is essential is a consistent data set, when labelling the products as well as on later verification of the products on the basis of the labelling. For reason of data protection, here a second data bank which is different to the first data bank can be used for verification, in order to deny the manufacturer access to the personal data of the end customer.

On account of identical first and second data banks, it is possible to access the same data on creating and examining the labelling, for example within the framework of an online examination which again increases the counterfeit protection. It is also alternatively possible for the data which is necessary for examining the labelling to be transmitted to further data carriers at certain, possibly previously set time intervals, in order to then verify the labelling offline.

Given a different first and second computation unit, it is possible to further increase the security by way of the different picture parts being transmitted from the first to the second computation unit in a separate manner and possibly on different and/or temporally staggered transmission paths. The security against counterfeiting is further increased by way of this, since the complete picture pattern cannot be read and/or copied in its entirety at a transmission node by the counterfeiter.

Given a different first and second data bank, the second data bank can be situated offline, for example on a smartphone of a user. Here, it is possible to firstly verify the picture pattern offline by way of the second data bank and to then compare the second data bank with the first data bank at a later stage, for example as soon as a connection exits. It is also possible to verify the picture pattern straight away by way of the first data bank which is stored online.

Moreover, it can be advantageous if a first and a second product which are part of a product series are labelled each with at least two picture parts, wherein the picture parts have been produced by a picture generator by way of pictorially fragmenting a picture pattern and have been applied onto at least a part of the respective product. Moreover, representations of the respective picture pattern have been stored in a first data bank on a first computation unit.

The at least two picture parts on the first and/or second product can moreover be read by a verification device which is further configured for putting together the picture parts into a composite picture pattern and for verifying the composite picture pattern on the basis of representations of the respective picture patterns which are stored in a second data bank of a second computation unit.

It is moreover possible for the first and second product which for example can be a medicine or another pharmaceutical product, to each comprise a packaging and for at least one first picture part to be applied on the packaging at the outside and at least one second picture part within the packaging. The packaging must therefore be opened before the product can be verified on the basis of all picture parts.

Here, according to one embodiment example, the packaging of the first and second product each comprise a safeguard (security feature), for example a seal which is not reclosable after opening, for example by way of mechanical opening such as tearing or cutting open. An improved counterfeiting safeguard is given by way of this, particularly in the context of a product serialisation, since the packaging needs to be opened and the seal therefore broken for counterfeiting. A damaged seal however would be evident to the seller and/or the customer. The serialised labelling of products, wherein at least one picture part is additionally protected by the safeguard of the packaging permits especially the end customer to examine the authenticity of the product. For example, the end-customer can read out all picture parts after opening the packaging, for example with the help of an app on a smartphone, and these are then automatically put together and verified by way of a data bank which is accessible online.

If the first and the second product is a pharmaceutical product, then the first and the second product can further each comprise a package insert and/or at least one packed product. The packed product for example can be a blister or an ampoule which contain the actual medicines. The package insert and the packed product are located within the packaging and the at least one picture part which is applied within the packaging is applied to the package insert and/or on at least one of the packed products. A picture part could also be applied onto the packaging from the inside, for example from the inside onto a tab to be opened.

Furthermore, it is possible to label a packaging unit which comprises several products, for example a pallet, so that a picture part of the picture pattern is applied onto the packaging unit and this together with a picture part which is applied at the outside onto the respective packaging are able to be verified for example by the trader. The end-customer in turn can then verify the authenticity of the product on the basis of the same or a further picture part at the outside on the packaging in combination with a picture part which is applied within the packaging. A further increased safeguard against counterfeiting can be achieved by way of such a cascaded labelling, since the authenticity of the product is verified at different points in time of the manufacture, marketing as well as use.

The following embodiment examples illustrate the construction and the possible fields of application of the method and system according to the invention with the help of the following figures.

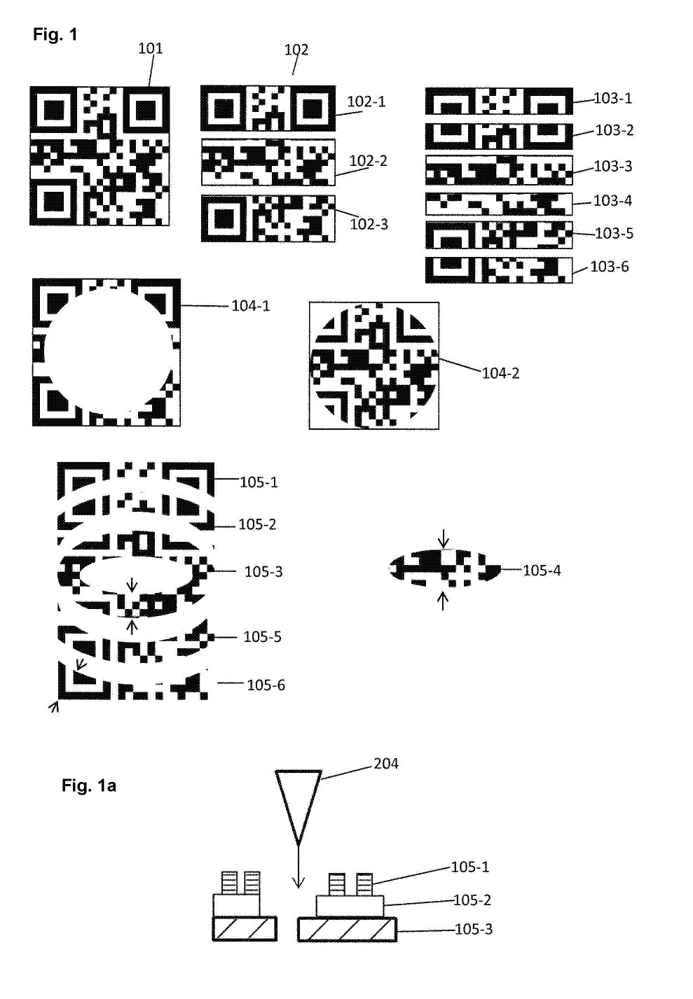

FIG. 1 shows a two-dimensional QR code which codes the word “Patent”, as well as several part-codes which are produced from this,

FIG. 1a shows a cross-sectional view of the operating manner of an ablative or abrasive laser,

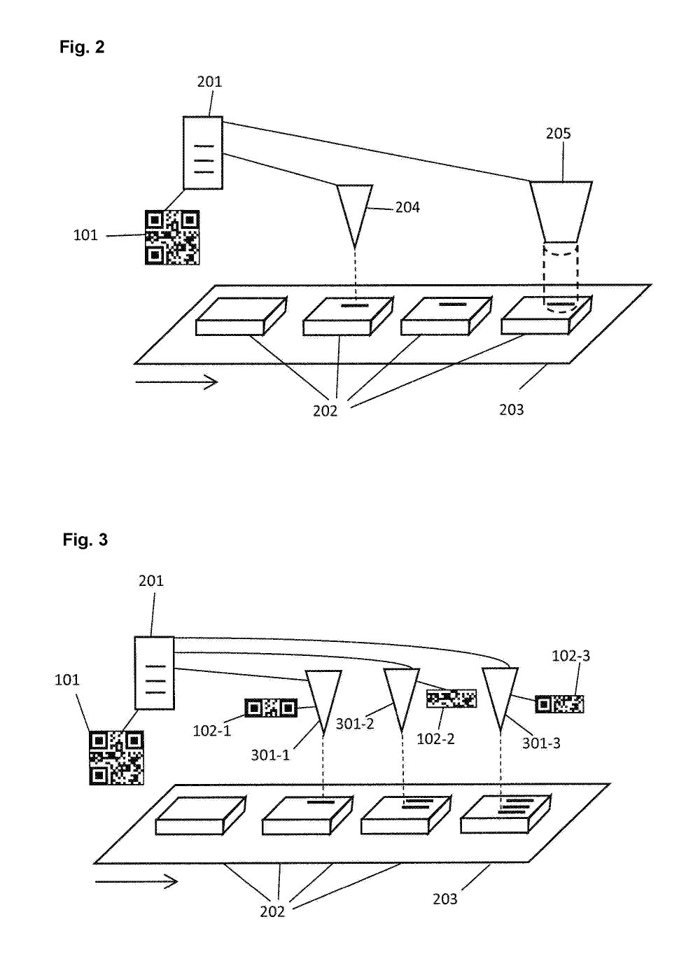

FIG. 2 shows a schematic view of an embodiment example of the system for applying a labelling,

FIG. 3 shows a schematic view of a further embodiment example of the system for applying a labelling,

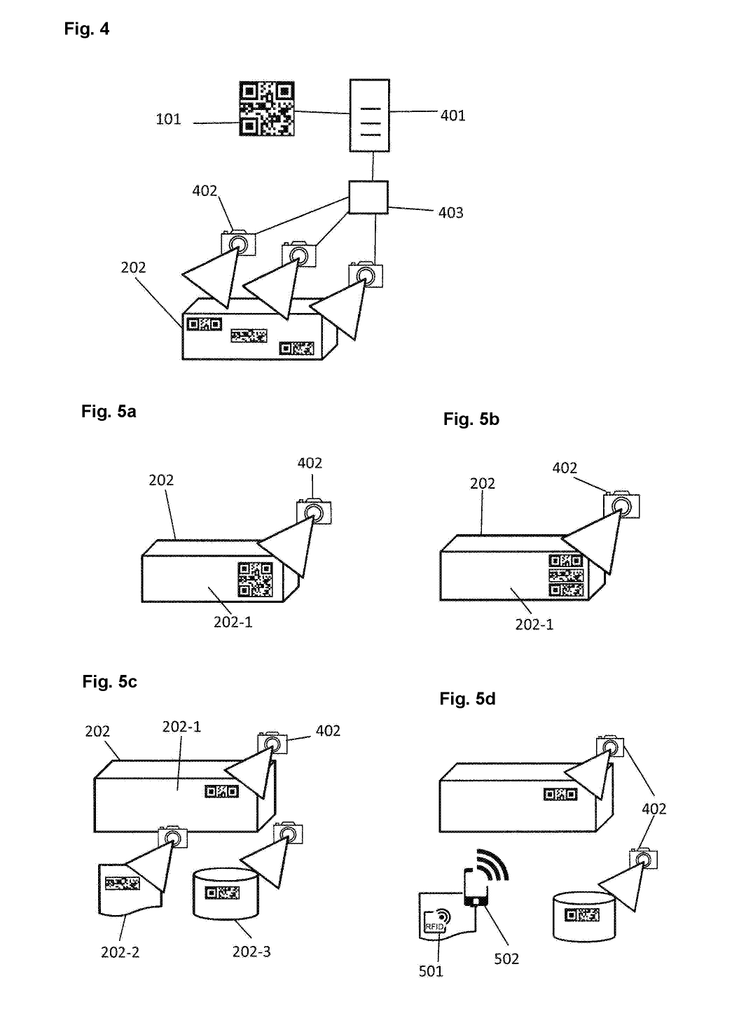

FIG. 4 shows a schematic view of an embodiment example of the system for reading a labelling,

FIGS. 5a-5d show schematic views of different variants of the labelling of products, as well as their reading methods,

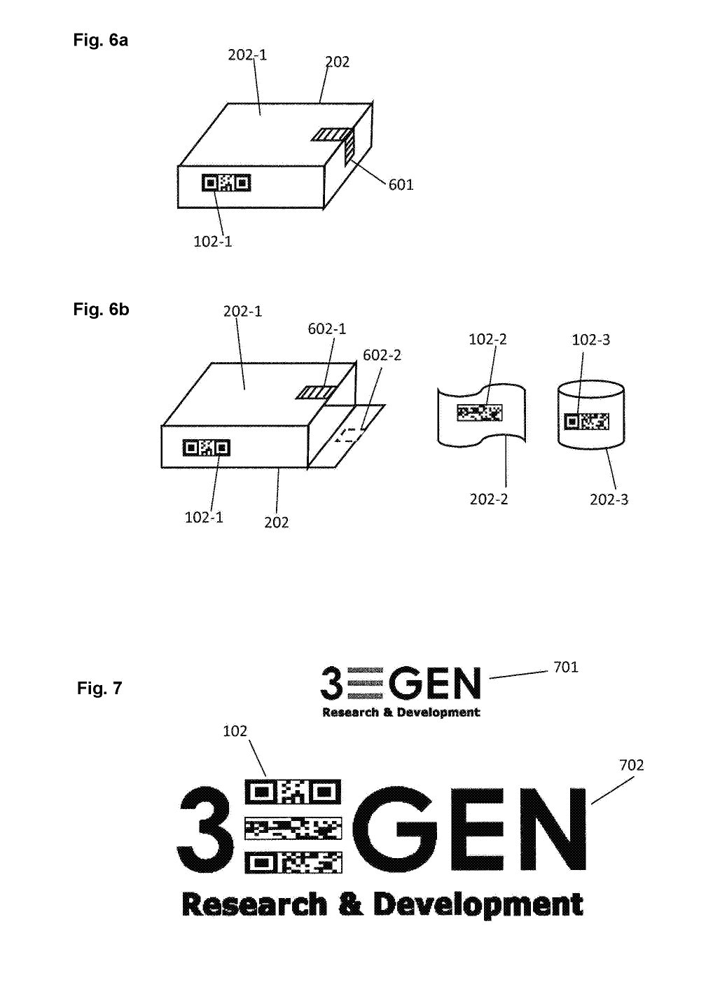

FIG. 6a shows a sealed, labelled product,

FIG. 6b shows the opened, unsealed product of FIG. 6a as well as its contents,

FIG. 7 shows the integration of a divided labelling into a logo,

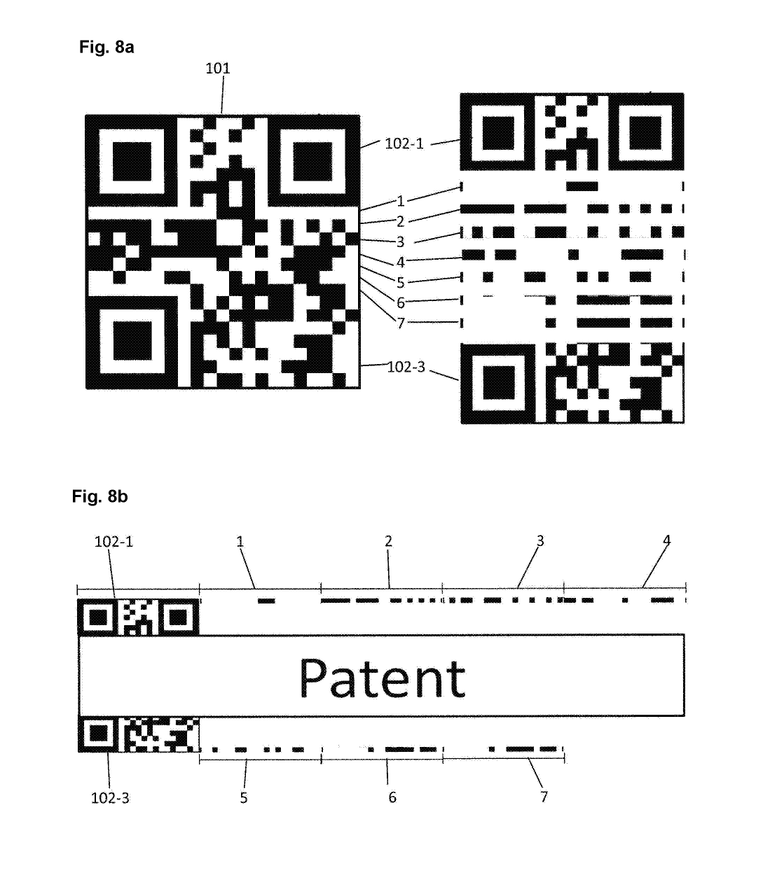

FIG. 8a shows the fragmentation of the two-dimensional code of FIG. 1 into differently large part-codes,

FIG. 8b shows the embedding of the part-code of FIG. 8a into a product,

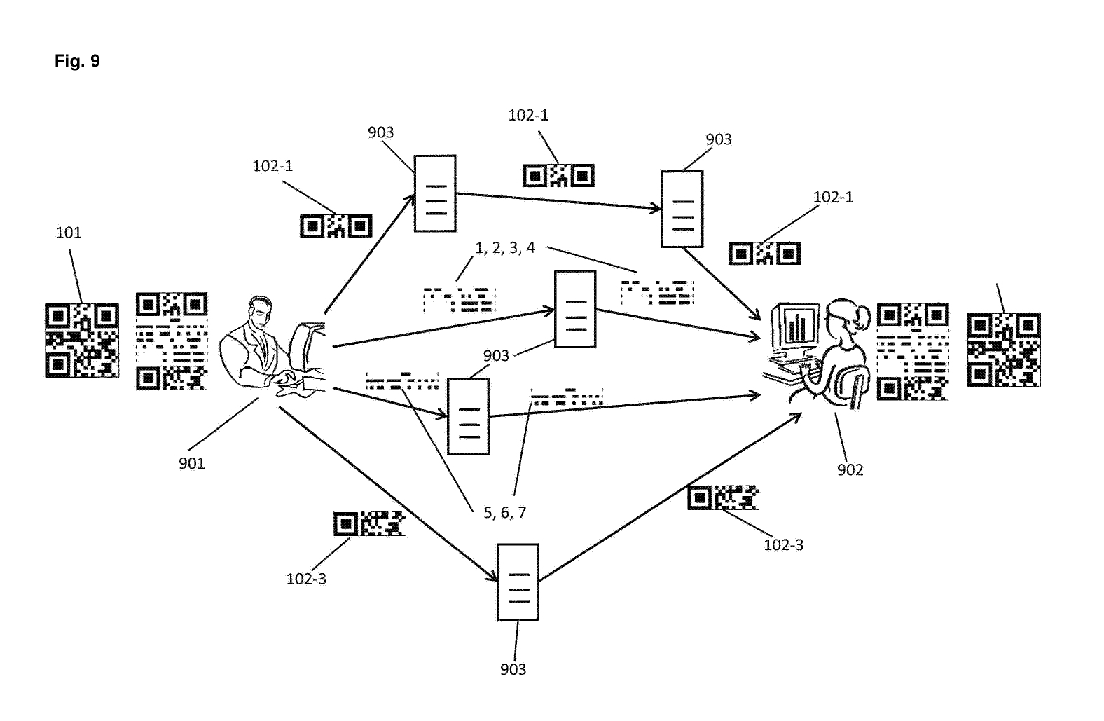

FIG. 9 shows the transmission of part-codes on different communication paths for increasing the security.

FIG. 1, in accordance with one embodiment example of the system for applying a labelling onto a product as well as of the corresponding method, shows that a picture pattern 101, in this case a two-dimensional QR code which codes the word “Patent”, is firstly produced by a picture generator.

The picture generator then fragments the produced picture pattern 101 into several picture parts. According to one embodiment example, the picture pattern 101 can be fragmented into a spatially non-continuous code 102 consisting of three rectangular picture parts 121-1, 102-2, 102-3. It is also possible to fragment the picture pattern into more than three picture parts, for example six strip-like picture parts 103-1, 103-2, 103-3, 103-4, 103-5, 103-6, or only into two picture parts 104-1, 104-2 which can have different shapes.

It is also possible for the picture generator to fragment the picture pattern 101 into several arcuate and/or irregular strips 105-1 to 105-6, wherein the maximal width is limited by the operating width of the respective laser. Since different lasers can also be applied for depositing the different strips, it is possible for different strips to have different maximal lengths.

The operating width of the laser is represented schematically at the strips 105-3, 105-4 and 105-6 by way of arrows. The ellipsoidal picture strips 105-3 can be deposited by way of a laser with the operating width which is shown by the arrows, wherein the laser is moved on a guide along the shape of the picture strip 105-3. In contrast, the oval picture strip 105-4 is deposited by a laser of the shown operating width whilst the laser is moved relative to an axis of the picture strip 105-4. The picture strip 105-4 is therefore partly narrower than the operating width of the laser. The laser with the shown operating width describes a curve on applying the picture strip 105-6.

Here, the coding and the redundancy of the picture strip 101 is selected such that the picture parts can only be interpreted in their entirely. In particular, the reconstruction of a missing picture part from the other picture parts is not possible or only coincidentally possible. For this, the coding is selected such that each picture part comprises individual information, and the redundancies which can be necessary for the correction of errors on contamination or damage to the picture pattern are designed such that they mainly serve for error correction within the respective the respective picture part, not however for error correction of the other picture parts.

The individual picture parts can also contain information for the correct putting-together, for example by way of a numbering of the picture parts. Moreover, the picture parts can contain information on the position of the further picture parts, these further picture parts being necessary for verification.

FIG. 1a shows the operating manner of an ablatively or abrasively operating laser for creating a coloured picture pattern with prominences, in the cross section. Different colour layers 105-1, 105-2, 105-3 are applied on the product and are partially detached by the laser 204. A multi-coloured picture pattern therefore arises, since the lower colour layers 105-2, 105-3 become visible due to the detachment of the upper colour layers 105-2, 105-3.

FIG. 2 shows an embodiment of the system for applying a labelling onto a product, as well as of the corresponding method. Here, the picture generator which is located in a first computation unit 201, for example a local computer or a remotely arranged server firstly produces a picture pattern 101 and stores the picture pattern 101 or a representation of the picture pattern 101 in a first data bank which is implemented on the computation unit 201. A first picture part 102-1 of the picture pattern 101 is then deposited onto a product 202 by a laser 204, wherein the product is located on a conveying belt 203. Here, it can be necessary for the conveying belt having to be stopped or at least slowed down, for applying the labelling, depending on the size of the picture pattern 101 or the picture part 102-1 which are to be printed on, and also depending on the speed of the conveying belt. If the maximal width of the picture part which is to be printed on does not exceed the operating width of the laser, then the depositing can be effected at normal speed of the conveying belt. Furthermore, the quality of the printed-on picture part 102-1 can be examined by a scanner 205.

Here, the laser can be an ablative or abrasive laser or be a commercially available laser printer. Moreover, other methods and systems for applying the labelling are possible, so that the labelling for example can be printed on, embossed, punched or bonded.

Here, it is also alternatively possible to use a multi-coloured picture pattern and/or a picture pattern with prominences, in order to increase the counterfeiting security. For this, in particular an ablative or abrasive laser can be used, said laser depositing the picture pattern or at least a first picture part of the picture pattern by way of partial detachment or scraping-away of a surface of the product 202 or of a packaging of the product 202.

FIG. 3 shows a further embodiment of the system for applying a labelling onto a product 202. Here, the produced picture pattern 101 or at least a representation of the picture pattern 101 is likewise stored in the first data bank of the first computation unit 201 and is divided by the picture generator into three picture parts 102-1, 102-2, 102-3 which one after the other are then printed onto the products 202 by three application devices 301-1, 301-2, 301-3 which can be designed for example as lasers, whilst the products 202 are transported on a conveying belt 203 at normal transport speed. A spatially non-continuous code for labelling the product therefore arises. Here, the lasers 301-1, 301-2, 301-3 are stationary. A deposition at normal transport speed is possible due to the narrow picture parts 102-1, 102-2, 102-3 which result from the division.

The surface of the product 202 or its packaging here can consist of paper, cardboard, plastic composite, glass composite, metal composite or a combination of these materials. Different application devices 204, 301-1, 302-2, 301-3 are necessary, depending on the surface of the product 202, in order to stick on, to emboss, to perforate, to punch, to laser or to print on the labelling.

An embodiment example of the system according to the invention, for reading the labelling of the product 202, is shown in FIG. 4. Here, the printed picture parts 302-1, 302-2, 302-3 are applied at different locations of the product 202 and are detected individually by a read device 402 such as for example a code scanner or a smartphone. The detected picture parts are then put together with the help of a verification device 403 which can be implemented for example as an app of a smartphone. The composed picture pattern is then compared to the representations of picture patterns 101 which are stored in a second data bank of a second computation unit 401. This comparison can be effected for example online within the scope of web service.

Here, it is possible to provide the products 202 with serialised picture patterns, so that each product 202 contains an individual labelling. In the second data bank, the respective representation of the picture pattern 101 is then marked as “already compared” after an effected comparison. An error notice is therefore generated given a renewed attempt to verify the same picture pattern 101 and this error notice notifies the user that a product counterfeit is possibly present.

Further embodiment examples for reading the labelling of the product 202 are shown in FIGS. 5a to 5d. As is shown in FIG. 5a, it is thus possible for the picture parts to have been applied by the lasers 301-1, 301-2, 301-3 in FIG. 3 such that a continuous code has arisen, said code being able to be detected as a continuous code by the read device 402. Here, one is to take particular care of an exact alignment on applying the labelling.

Alternatively, as is shown in FIG. 5b, the picture parts 102-1, 102-2, 102-3 can be spatially separated, but despite this are still detectable by a single read procedure.

FIG. 5c shows that the picture parts 102-1, 102-2, 102-3 are deposited on different parts, specifically a packaging 202-1, a package insert 202-2 and a medicine blister 202-3 of a pharmaceutical product 202, and are detected by way of separate laser procedures.

As is shown in FIG. 5d, a further variant lies in only some, but not all picture parts which are necessary for decoding, being applied onto the product 202. Here, at least one further picture part needs to be additionally obtained, for example by way of a web service 502 or an RFID transponder 501 which can be arranged on the packaging, the pallet or at another location.

According to a further embodiment example, the first computation unit 201 and the second computation unit 401 as well as the first data bank and the second data bank are respectively identical, so that the verification of the read, composite picture pattern is effected on the basis of the representation of the picture pattern 101, said representation being stored on producing the picture pattern 101.

A pharmaceutical product 202, on whose packaging 202-1 a picture part 102-1 of the serialised labelling of the pharmaceutical product 202 is located, is shown in FIG. 6a. The pharmaceutical product 202 additionally has a seal 601 which is destroyed on opening the packaging 202-1 of the pharmaceutics product 202.

FIG. 6b shows the pharmaceutical product 202 of FIG. 6a after the opening of the packaging 202-1 and the seal 601. The seal 601 was broken up into two parts 602-1 and 602-2 on opening and can no longer be reconstructed. The further constituents of the pharmaceutical product 202, in this case a package insert 202-2 and a medicine blister 202 can be removed after opening the packaging 202-1. A further picture part 102-2 and 102-3 are located on the package insert 202-2 and on the medicine blister 202-3 respectively. The product 202 can only be successfully verified on reading all of the picture parts 102-1, 102-2, 202-3. If further parts are contained in the packaging, for example due to the presence of several medicine blisters, then it is optionally possible to likewise label these with another or an identical picture part.

Here, it is moreover possible for the products of a product series to partly comprise identical labellings and for only a part of the individual product labelling to be produced in a serialised and individual manner as a serial number.

The counterfeiting protection can be increased by way of a combination of a sealed packaging, at least one picture part within the packaging and a serialised picture pattern, since a product counterfeiter must open an original product and therefore render it invalid, in order to get to all necessary picture parts. If now the product counterfeiter uses the same picture pattern several times for labelling counterfeited products, then the probability of the counterfeiting being noticed at an early stage is increased. The risk and/or the effort for the product counterfeiter therefore increase and the counterfeiting of products becomes increasingly unprofitable.

FIG. 7 shows how a spatially non-continuous code 102 can be embedded into a logo 701, by which means a new logo 702 arises. The spatially non-continuous code can be detected and put together with a read device, for example by an app of a smartphone.

FIG. 8a again shows the picture pattern 101 from FIG. 1, said pattern being divided into differently large picture parts 102-1, 2, 3, 4, 5, 6, 7 and 102-3. The strip-like picture parts 1, 1, 3, 4, 5, 6, 7 can now be integrated into the product, into the packaging of the product or into a product label, as is shown in FIG. 8b, in a manner such that at first glance, the picture parts cannot be perceived at all by the user as being part of the coding.

If the user now scans at least one of the picture parts 102-1 and 102-3 with his smartphone, then via the display of the smartphone he is instructed to please scan the complete packaging side which is to say the complete product label. The picture parts 102-1, 102-3, 1, 2, 3, 4, 5, 6, 7 after they have been scanned by the smartphone are put together by an app on the smartphone, by which means again the original picture pattern 101 arises.

FIG. 9 shows how the security can be additionally increased by way of the picture parts 102-1, 102-3, 1, 2, 3, 4, 5, 6, 7 of the picture pattern 101 being sent from the sender 901 to the receiver 902 via different communications channels or paths. Here, the picture parts are each transmitted from the sender 901 to the receiver 902 via different transmission nodes 902. After the receipt of all picture parts 102-1, 102-3, 1, 2, 3, 4, 5, 6, and 7, the receiver 902 can reconstruct the picture pattern 101, but for a hacker it is however not possible to obtain the complete picture pattern 101 by way of access to only one transmission node 903.

1. A system for applying and/or reading a labelling of a product, comprising
a system for applying a labelling of the product comprising
a picture generator configured for producing a picture pattern and for the pictorial fragmentation of the produced picture pattern into at least two picture parts,
an application device configured for applying at least one of the picture parts onto at least one part of the product,
a first computation unit, comprising a first data bank, configured for storing a representation of the produced picture pattern;
and/or
a system for reading the labelling of the product (202) comprising
a second computation unit, comprising a second data bank, configured for storing a representation of a picture pattern;
a verification device, configured for reading at least two picture parts, for putting together the picture parts into a composite picture pattern and for verifying the composite picture pattern on the basis of the representation of the picture pattern which is stored in the second data bank.

2. The system according to claim 1, characterised in that the picture generator is further configured for producing and fragmenting the picture pattern in a manner such that each of the picture parts comprises individual information which cannot be reconstructed from the other picture parts.

3. The system according to claim 2, characterised in that the produced picture pattern comprises redundancies.

4. The system according to claim 2, characterised in that the produced picture pattern is a plane, two-dimensional picture pattern.

5. The system according to claim 4, characterised in that the produced picture pattern is a QR code.

6. The system according to claim 1, characterised in that the produced picture pattern comprises prominences.

7. The system according to one of the preceding claim 2, characterised in that the picture generator is configured for fragmenting the produced picture pattern into three picture parts.

8. The system according to claim 2, characterised in that the produced picture pattern is serialised and is provided for application onto precisely one product), and that the second computation unit is configured for marking the representation of the stored picture pattern in the second data bank after verification of the composite picture pattern on the basis of the representation of the picture pattern which is stored in the second data bank.

9. The system according to claim 1, characterised in that the picture pattern is a multi-coloured picture pattern.

10. The system according to claim 1, characterised in that the application device comprises an ablative or abrasive laser for applying at least one picture part onto at least one part of the product.

11. The system according to claim 1, characterised in that the system comprises a movable unit, suitable for moving the application device and the product relative to one another.

12. The system according to claim 1, characterised in that the application device comprises a predefined operating width, and the picture generator is configured to fragment the picture pattern into at least two strips which at the most are as wide as the predefined operating width, wherein the strips are straight and/or arcuate strips.

13. A method for applying and/or reading a labelling of a product, comprising the following steps:
applying the labelling onto the product by
producing a picture pattern and dividing the picture pattern into at least two picture parts,
storing the picture pattern in a first data bank of a first computation unit,
applying at least one of the picture parts onto the product; and/or
reading the labelling of the product (202) by way of
detecting at least one of the picture parts which are applied on the product, by way of a read device,
putting together the picture parts into a composite picture pattern,
comparing the composite picture pattern with a picture pattern which is stored in a second data bank of a second computation unit.

14. The method according to claim 13, characterised in that the application of the picture parts onto the product is effected on a movable unit and/or with a movable or stationary ablative or abrasive laser.

15. The system according to claim 1, characterised in that the first computation unit and the second computation unit are identical and/or the first data bank and the second data bank are identical and/or the picture pattern which is stored in the first data bank and the picture pattern which is stored in the second data bank are identical.

16. A first and a second product, each labelled with the system according to claim 1, wherein at least two picture parts are applied on the first and the second product and that the first and the second product are part of a product series.

17. The first and second product according to claim 16, characterised in that the first and the second product each comprise a packaging and at least one first picture part is applied on the packaging at the outside and at least one second picture part is applied within the packaging.

18. The first and second product according to claim 17, characterised in that the packaging of the first and of the second product each comprise a safeguard which cannot be recreated after opening.

19. The first and second product according to claim 16, characterised in that the first and the second product is a pharmaceutical product, each further comprising a package insert and/or at least one packaged product, wherein the at least one picture part which is applied within the packaging is applied on the package insert and/or on one of the at least one inner packaged products.
